(19) United States
(12) Patent Application Publication
(10) Pub. No.: US 2026/0293919 A1
(43) Pub. Date: Oct. 1, 2026

(54) METHOD FOR REDUCING GERMS IN DRIED FRUIT CONTAINING OIL AND/OR FAT, AND REFINING-GRINDING ARRANGEMENT

(71) Applicant: HAMBURG DRESDNER MASCHINENFABRIKEN VERWALTUNGSGESELLSCHAFT MBH, DRESDEN (DE)

(72) Inventor: TOBIAS LOHMUELLER, FREIBERG AM NECKER (DE)

(73) Assignee: HAMBURG DRESDNER MASCHINENFABRIKEN VERWALTUNGSGESELLSCHAFT MBH, DRESDEN (DE)

(21) Appl. No.: 18/874,095

(22) PCT Filed: Jun. 29, 2023
(86) PCT No.: PCT/EP2023/067756

§ 371 Date: Dec. 12, 2024

(30) Foreign Application Priority Data
Jun. 29, 2022 (DE) 10 2022 116 186.2

(51) Int. Cl. A23B 80/00; A23B 2/00; A23B 2/40; A23B 2/94; A23G 1/00; A23G 1/06; B02C 19/00

(52) U.S. Cl. CPC A23B 80/00; A23B 2/001; A23B 2/003; A23B 2/405; A23B 2/945; A23G 1/002; A23G 1/06; B02C 19/0056

(57) ABSTRACT

A method of reducing a germ count of dried fruits which comprise oil and/or fat. The method includes filling the dried fruits into a treatment housing part of a housing arrangement and heating the treatment housing part, starting at least one refining process, reaching a predetermined maximum temperature<110° C., conducting moisture as water and/or as steam into the treatment housing part, and drying so as to obtain a refinement product.

### CROSS REFERENCE TO PRIOR APPLICATIONS

This application is a U.S. National Phase application under 35 U.S.C. § 371 of International Application No. PCT/EP2023/067756, filed on Jun. 29, 2023 and which claims benefit to German Patent Application No. 10 2022 116 186.2, filed on Jun. 29, 2022. The International Application was published in German on Jan. 4, 2024 as WO 2024/003207 A1 under PCT Article 21(2).

### FIELD

The present invention relates to a method of reducing the germ count of oil- and/or fat-containing dried fruits, in particular cocoa beans, wherein the dried fruits are subjected to at least a temperature treatment and a moisture supply in a housing arrangement. The present invention is also directed to a refining-grinding arrangement for carrying out the method.

### BACKGROUND

Oil- and/or fat-containing dried fruits must be pre-treated. For example, cocoa beans are fermented and stored during which the dried fruits can be contaminated with pathogens, wherein salmonellae are in particular regarded as the most risky contaminating germs for later consumption. When it comes to products that are to be roasted, such as, for example, cocoa beans, the roasting process is used to reduce the germ contamination during the further processing of the dried fruit due to the effect of heat, whereby it must be noted that an excessively intensive heat treatment leads to undesirable flavors which are, of course, also not desired when processing the dried fruit. Methods that use ionizing radiation or gamma radiation have also been developed to further reduce germ contamination. However, these methods require a further treatment step and are therefore expensive and time-consuming.

Another method of reducing the germ count is described in DE 34 17 125 A1 where the dry fruits are converted into a pourable and/or flowable mass by adding moisture and then subjected to a sudden increase and subsequent sudden decrease in temperature and pressure, followed by homogenization under vacuum to achieve a germ reduction. This method also requires additional effort or fundamentally new devices, however, in order to achieve the maximum values with regard to pressure and temperature and to be able to provide the vacuum. The high heat input also still carries the risk of a change in taste.

### SUMMARY

An aspect of the present invention is to avoid the above-mentioned disadvantages in a simple and cost-effective manner.

In an embodiment, the present invention provides a method of reducing a germ count of dried fruits which comprise oil and/or fat. The method includes filling the dried fruits into a treatment housing part of a housing arrangement and heating the treatment housing part, starting at least one refining process, reaching a predetermined maximum temperature<110° C., conducting moisture as water and/or as steam into the treatment housing part, and drying so as to obtain a refinement product.

### BRIEF DESCRIPTION OF THE DRAWINGS

The present invention is described in greater detail below on the basis of embodiments and of the drawings in which:

FIG. 1 shows a perspective sectional view of a refining-grinding arrangement according to the present invention; and

FIG. 2 shows a diagram for germ reduction as a function of the temperature of a treatment drum and time.

### DETAILED DESCRIPTION

The present invention provides a method having a first step of filling the dried fruit into a treatment housing part and heating the treatment housing part of the housing arrangement, a second step of starting at least one refining process, a third step where a predetermined maximum temperature T_{M}<110° C. is reached, a fourth step where moisture in the form of water and/or vapor is introduced into the treatment housing part, and a fifth step where a refinement product is at least dried. In the context of cocoa beans and the chocolate to be produced therefrom, “refining” is understood to mean “conching”, wherein the chocolate is constantly circulated and kneaded, wherein volatiles are in turn removed. The maximum temperature “T_{M}” refers to the temperature in the treatment housing part.

A particularly careful and effective method of reducing the germ count is achieved by preheating the treatment housing part to approximately T_{M}=90° C.

A moist atmosphere is provided that significantly supports decontamination if moisture in the form of water is added at the beginning of the process in a quantity of 2 g/100 g [water/dry fruit], maximum 5 g/100 g, wherein further moisture is added at defined time intervals. The addition of moisture can, for example, be monitored gravimetrically or volumetrically. The humid atmosphere can also be monitored.

Sticking can be sustainably avoided, even at high humidity, if an exchange of air mass (which is also known as open process control) is possible during the process. This exchange of air mass can occur in a controlled manner to facilitate the monitoring of the humidity in the treatment housing part. This can occur, for example, by opening and closing the treatment housing part or also by aspiration.

The processing sequence can be made even more efficient and the germ reduction can be further improved if an additional grinding process is started in the second step alongside the finishing process. The fact that the grinding process is carried out with the greatest possible grinding pressure in particular results in a high germ reduction with the best possible flowable finishing product.

The present invention also provides a refining-grinding arrangement for performing a method, wherein a housing arrangement with a drive device for a drive shaft and a control device are provided, which comprises a treatment drum in which a plurality of kneading wheels rotatable about a drive shaft are provided, wherein the kneading wheels are connected to the drive shaft, wherein a grinding arrangement is provided between the kneading wheels and the treatment drum, wherein a heating device is provided for the treatment drum, wherein a connection device for supplying moisture is provided, and wherein the control device is configured to control at least the maximum temperature T_{M} and the supply of moisture for the purpose of germ reduction. A very simple and efficient germ reduction during a refining-grinding process is possible via a suitable control of a refining-grinding arrangement so configured.

The grinding arrangement can, for example, be adjustable. The grinding arrangement can in this case be constructed from grinding arms directed at the kneading wheels to the treatment drum and from grinding rods provided at an inner side of the treatment drum, wherein the grinding arms are adjustable with respect to their inclination angle.

A measuring sensor for measuring moisture can, for example, be provided in the treatment housing part.

The present invention is explained in greater detail below with reference to the drawings.

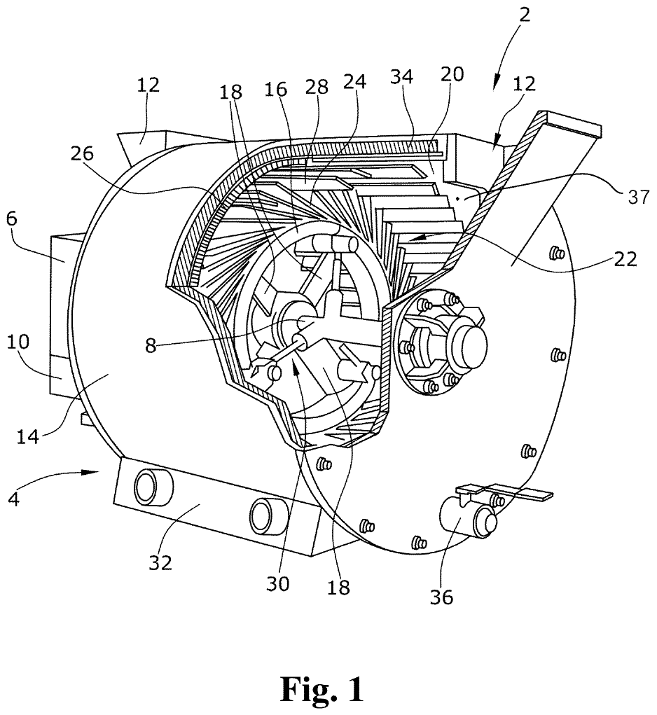

FIG. 1 shows a perspective sectional view of a refining-grinding arrangement 2 according to the present invention. A chocolate product is to be produced in the present case so that this can also be referred to as a conching process. The refining-grinding arrangement 2 comprises a housing arrangement 4 with a schematically indicated driving device 6 for a drive shaft 8. A control device 10 is also shown schematically which, as will be described below, controls certain process parameters to influence a germ reduction of a conching product, in this case chocolate.

In the shown refining-grinding arrangement 2, the cocoa beans are fed via a funnel 12 into a treatment housing part which is designed as a treatment drum 14 in order to be subjected to a conching and grinding process. For this purpose, several kneading wheels 16, of which only one is here shown, are provided in the treatment drum 14. These kneading wheels 16 are connected to the drive shaft 8 via kneading arms 18. The kneading wheels 16 with the associated kneading arms 18 perform the conching process. A grinding arrangement 22 is provided between the kneading wheels 16 and an inner side 20 of the treatment drum 14.

The grinding arrangement 22 essentially consists of grinding arms 24 which are directed towards treatment drum 14 at the kneading wheels 16, and of grinding rods 26 which are provided at the inner side 20 of treatment drum 14.

The grinding arms 24 are provided with a carrier plate 28 at their free end so that a grinding pressure can be set via an inclination angle of the grinding arms 24 via a grinding pressure setting device 30.

A heating device 32 is provided to heat the treatment drum 14. The heating device 32 is fluidically connected to a hot water jacket 34 of the treatment drum 14. Moisture can be supplied to the treatment drum 14 via a connection 36. Reference is made to GB 2 317 840 A for further basic information on the design of such a refining-grinding arrangement. A measuring sensor 37 is arranged in the treatment drum 14 to measure the moisture therein.

In order to achieve the best possible germ reduction in the cocoa beans to be treated in a conching-grinding process that is as gentle as possible in the refining-grinding arrangement 2 described above, a method of reducing the germ count of the cocoa beans is described as follows. In this process, the treatment drum 14 of the housing 4 is preheated to a temperature of T_{M}=90° C. in a first step. After reaching this temperature, the cocoa beans are introduced into the treatment drum 14 via the funnel 12 in a second step. In a third step, the conching process and the grinding process are then started, wherein, in a fourth step, at the beginning of the processes, moisture in the form of water, in this case 2 g/100 g (water/dry fruits), is added via the connection 36. Further moisture is then added at further defined time intervals. The control of the humidity and temperature in the treatment drum 14 is carried out via the control device 10. This all happens in an open process that makes it possible to exchange the air mass during the conching and grinding process. The grinding process is carried out with the greatest possible formal pressure to provide the flowability of the conching product, in this case chocolate, and to avoid sticking or clumping of the chocolate.

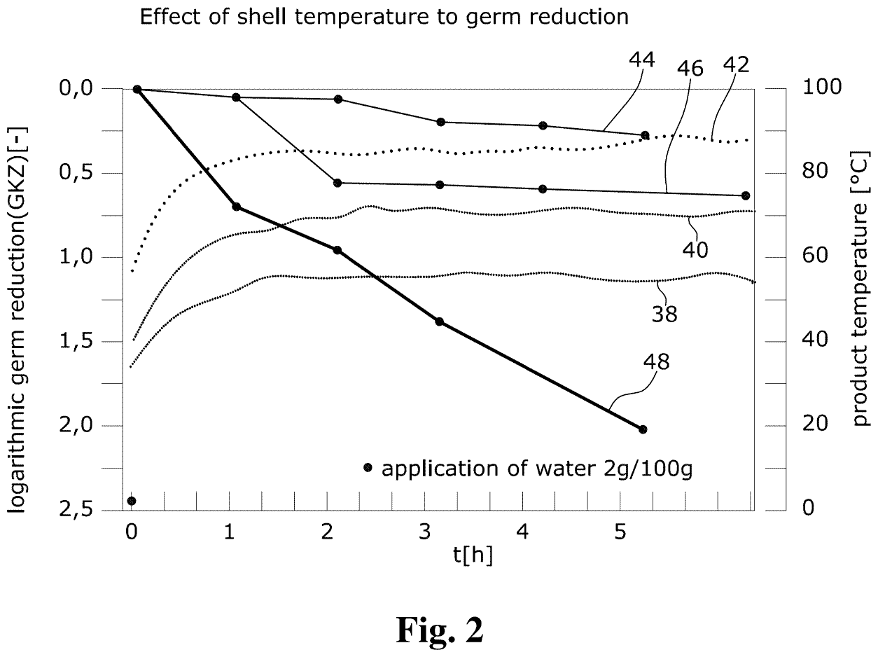

FIG. 2 shows a diagram of the influence of the shell temperature on the germ reduction, wherein a moisture addition in the form of water of 2 g/100 g was carried out during an open system control. In a first experiment, the treatment drum was preheated to a temperature of 60° C., in a second experiment to 80° C., and in a third experiment to 90° C. The product temperature, which is substantially below the temperature of the treatment drum, is shown at the right-hand y-axis via curves 38, 40 and 42. The effects on the germ reduction can then be seen at curves 44, 46 and 48, wherein curve 44 corresponds to the treatment temperature of 60° C., curve 46 to the treatment temperature of 80° C. and curve 48 to the treatment temperature of 90° C. The greatest reduction in germs, which can be read at the left-hand y-axis in logarithmic form (log reduction), was achieved at a temperature of T_{M} 90° C. in the treatment drum.

The present invention is not limited to embodiments described herein; reference should be had to the appended claims.

### LIST OF REFERENCE NUMERALS

2 Refining-grinding arrangement
4 Housing arrangement
6 Driving device
8 Drive shaft
10 Control device
12 Funnel
14 Treatment drum
16 Kneading wheel
18 Kneading arms
20 Inner side (of treatment drum 14)
22 Grinding arrangement
24 Grinding arm
26 Grinding rod
28 Carrier plate
30 Setting device
32 Heating device
34 Hot water jacket
36 Connection
37 Measuring sensor
38 Product temperature curve for Experiment 1
40 Product temperature curve for Experiment 2
42 Product temperature curve for Experiment 3
44 Germ reduction curve of Experiment 1 (treatment temperature of 60° C.)
46 Germ reduction curve of Experiment 2 (treatment temperature of 80° C.)
48 Germ reduction curve of Experiment 3 (treatment temperature of 90° C.)

1-10. (canceled)

11: A method of reducing a germ count of dried fruits which comprise oil and/or fat, the method comprising:
filling the dried fruits into a treatment housing part of a housing arrangement and heating the treatment housing part;
starting at least one refining process;
reaching a predetermined maximum temperature<110° C.;
conducting moisture as water and/or as steam into the treatment housing part; and
drying so as to obtain a refinement product.

12: The method as recited in claim 11, wherein the dried fruits are cocoa beans.

13: The method as recited in claim 11, further comprising:
preheating the housing arrangement to approximately 90° C.

14: The method as recited in claim 11, wherein,
water is conducted as the moisture into the treatment housing part;
the water is conducted into the treatment housing part in a quantity of from 2 g to 5 g/100 g [water/dried fruit] at at least a beginning of the at least one refining process, and
moisture is subsequently conducted into the treatment housing part at defined time intervals.

15: The method as recited in claim 11, wherein the at least one refining process is performed as an open process control which provides for an exchange of air mass.

16: The method as recited in claim 11, further comprising:
starting a grinding process alongside the at least one refining process.

17: The method as recited in 16, wherein the grinding process is performed with a greatest possible grinding pressure.

18: A refining-grinding arrangement for performing the method as recited in claim 16, the refining-grinding arrangement comprising:
the housing arrangement which comprises a control device and a driving device, the driving device being configured to drive a drive shaft;
a treatment drum as the treatment housing part;
a plurality of kneading wheels which are configured to rotate via the drive shaft;
kneading arms which are configured to connect the plurality of kneading wheels to the drive shaft;
a grinding arrangement which is arranged between the plurality of kneading wheels and the treatment drum;
a heating device which is configured to heat the treatment drum; and
a connection which is configured to provide a supply of moisture,
wherein,
the control device is configured to control at least a maximum temperature and the supply of the moisture so as to reduce the germ count.

19: The refining-grinding arrangement as recited in claim 18, wherein the grinding arrangement is configured to be adjustable.

20: The refining-grinding arrangement as recited in claim 19, wherein,
the grinding arrangement comprises,
grinding arms which are directed at the plurality of kneading wheels towards the treatment drum, and
grinding rods which are arranged at an inner side of the treatment drum, and
the grinding arms are configured to have an adjustable inclination angle.

21: The refining-grinding arrangement as recited in claim 18, further comprising:
a measuring sensor which is arranged in the treatment housing part, the measuring sensor being configured to measure the moisture in the treatment housing part.
